(19) United States
(12) Patent Application Publication
(10) Pub. No.: US 2006/0158758 A1
(43) Pub. Date: Jul. 20, 2006

(54) Safe distance indicator

(76) Inventor: Robert E. White SR., Westminister, SC (US)

Correspondence Address: Stephen R. Chapman, 1220 Baypoint Drive, Seneca, SC, 29672, US

(21) Appl. No.: 11/036,226

(22) Filed: Jan. 14, 2005

(51) Int. Cl. G02B 5/08

(52) U.S. Cl. 359/871; 359/850

(57) ABSTRACT

Pairs of visually discernable reference points applied to a rearview mirror such that the operator of a vehicle may estimate the distance to a following vehicle based on the width of the reflected image of the following vehicle with respect to one or more pairs of the visually distinguishable reference points.

### FIELD OF THE INVENTION

The invention is directed to automotive safety devices, specifically to devices that may prevent accidents, and more specifically to a device and system that allows the driver of a lead vehicle to rapidly and simply estimate the distance of a following vehicle, thereby potentially reducing the incidence of rear-end collisions.

### BACKGROUND OF THE INVENTION

Collisions between motor vehicle exact an enormous annual toll in terms of injuries and property damage. Rear-end collisions are among the most common vehicle collisions with over 2.5 million such accidents reported annually. The most common injury is the “whip lash” injury to the neck, frequently suffered by occupants of vehicles struck from behind; that is occupants of a lead vehicle struck by a following vehicle.

As is the case for most accidents, no single cause explains all accidents, and no single remedy will prevent most types of accidents. In the case of rear-end collisions, the most obvious cause is the following vehicle approaching a slower moving, lead vehicle to rapidly and being unable to stop or decelerate adequately before striking the lead vehicle, or simply following to closely (tail-gateing) and being unable to stop when the lead vehicle decelerates or stops. A significant number of rear-end collisions are caused by a slower moving vehicle pulling away from a curb, or changing lanes into a path of a vehicle approaching from the rear that is too close to avoid colliding with it. In the first situation, are occupants of the lead vehicle warned of an impending collision so that the driver can take some type of evasive action, warn the approaching vehicle, or at least warn passengers to brace for the anticipated collision. In the second situation, commonly the driver may have noticed the approaching vehicle in the rear view mirror, but failed to reasonably estimate the distance between the vehicles.

Changes in several aspects of vehicle design reflect significant efforts to reduce whip-lash and other injuries. Among common examples are improved seat belt restraint systems, air bags that deploy instantly on impact, and head rests designed specifically to protect against the whip lash effects of a rear end collision.

In addition, a variety of electronic devices have been proposed to warn drivers rapidly approaching vehicles or vehicles that are following too closely for reasonable safety. Some devices even warn the approaching (following) vehicle that it is not separated from the lead vehicle by a reasonably safe distance.

For example, U.S. Pat. No. 6,590,495, “Automobile distance warning and alarm system,” issued to Behbehani on Jul. 8, 2003 claims a complex system that considers road and weather conditions in addition top vehicle speed to calculate the time separating a proximate vehicle and converts the time to a safe separation distance. When the distance is not maintained, visual and audio warnings are triggered. Based on safety studies, the distance is calculated on the distance a vehicle will travel in 3 seconds (88 feet in 3 seconds at 60 mph for example).

In an alternative scheme, U.S. Pat. No. 6,534,884, “proximity sensing system for vehicles.” issued to Marcus, et al. on Mar. 18, 2003 depends on a reward sensing proximity sensing system to warn a driver when a following vehicle enters a defined area behind the lead vehicle. The system of the '884 patent may also incorporate a visual “tail gating” warning to the driver of the following vehicle.

In yet an even more complex system, U.S. Pat. No. 6,498,620, title, “Vision system for a vehicle including an image capture device and display system having a long focal length,” issued Dec. 24, 2002 to Schofield, et al., claims a projector system in which a rear facing camera projects images of following traffic on a screen (a modification of the common rear-view mirror). Properly mounted and adjusted, this system provides a full view to the rear of the vehicle and eliminates the need for side-mounted, rear view mirrors. While providing a desirable field of view, as described and claimed, the system does little apparently to estimate distances and safe separation of following vehicles.

The blind spot common to rear view mirrors, regardless of where or how they are mounted is reduced by a combination of two flat mirrors joined at a prescribed angle to allow images in one mirror to be reflected to and seen in a second mirror thereby reducing the blind spot, as claimed in U.S. Pat. No. 6,523,965, “Driver's rear view mirror,” issued Feb. 28, 2003 to Luger. The mirrors haver demonstrated safety advantages, but do not address determining distances separating vehicles.

The inventions claimed in the '459 and '884 patents depend on relatively sophisticated technology, and may either overload the driver with information (speed, stopping distances) or distract the driver from other responsibilities. The '620 patent provides a continuous, clear rear view, but does not provide any safe following or vehicle separation information, which also is a deficiency of the '965 patent. In addition, the reflection of a reflection used to overcome the blind spot may be distracting to a driver.

There remains need for a simple device that allows the driver of a lead vehicle to simply, without any sophisticated electronics, estimate the distance between the lead vehicle and following vehicles and determine whether the following vehicles are dangerously close. Accordingly, there remains room for improvements in rear view mirror systems and devices.

### SUMMARY OF THE INVENTION

A primary goal of the invention is a modification to rear view mirrors that allows the operator of a lead vehicle to simply and quickly, visually estimate the distance by which a following vehicle is separated from the lead vehicle.

An additional goal of the invention is a device whereby a modification to a rear view mirror to estimate distances to following vehicles can be exchanged to adjust for differences in the total length of the lead vehicle when, for example, the lead vehicle is towing a trailer.

A still further goal of the invention is a variety of means by which modifications to rear view mirrors that allow visual estimation of distances separating the vehicle from a following vehicle to be positioned in the field of view of the rear view mirror for effective use by the vehicle operator.

These and other goals and purposes can be achieved by a rear view mirror with one or more pairs of markings that appear on the reflective surface of the rear view mirror such that the distance the markings represents the a defined distance of an object of specific, known size (width or height) behind the vehicle. Thus is the reflected image of a following vehicle is as wide, or wider than the space between the markings, the vehicle is as closer, or closer than a predetermined distance, and the goals and purposes can be further achieved be having more than one pair of markings to indicate increasing or decreasing distances separating a following vehicle from a lead vehicle; these and other goals and purposes are further achieved by adjusting the space between markings on the surface of a mirror to compensate for flat mirrors typical of driver's compartment, interior review view mirrors and driver's side, exterior side mounted mirrors, compared with convex shaped mirrors commonly used as side mounted, exterior rear view mirrors on the side opposite the driver's side of the vehicle; the purposes and goals are still further achieved by an auxiliary, frame like device capable of being attached to the rear view mirror of a vehicle and capable of supporting a transparent material with markings thereon wherein such markings indicate the distance to a reflected object of a predetermined size, and finally these and other purposes and goals can be achieved by a rigid, transparent insert capable of being positioned in the above described frame and by transparent tape material with distance measuring markings thereon capable of being adhesively fixed to the surface of a mirror.

### EXAMPLES

Principles

The invention depends on certain basic principles of physics and human eye sight. A brief review of both, including a simple mirror aids in understanding the invention.

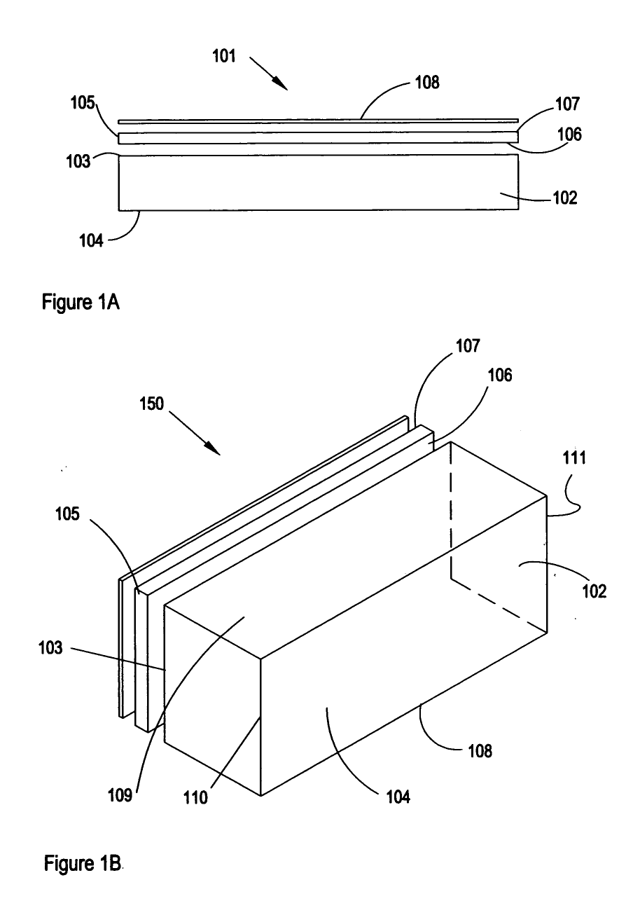

FIG. 1A illustrates a top view 101 of the basic layers comprising a flat (plane) mirror, and FIG. 1B illustrates a front view 111 of the same mirror. Numbering of the various elements is consistent between the two views.

Although virtually any “shinny” surface can act as a mirror, in the present context, a flat (plane) mirror comprises three basic elements: a transparent foundation 102 with an inner face 103 and an outer face 104; a smooth, reflective material 105 (frequently mercury), which is applied to the inner surface 103 of the transparent foundation 102, such that the outer surface 106 of the reflective material 105 uniformly coats the inner face 103 of the transparent foundation 102, and the exterior surface 107 of the reflective material is covered with a protective coating 108. The outer surface 104 of the transparent foundation 102 is commonly considered to be the surface of the mirror and hereinafter, “surface of the mirror” refers to that surface.

In addition to the transparent foundation 102, reflective material, 105 and protective coating 108, mirrors, particularly as used in vehicles, may have auxiliary frames and related adjustable mountings to secure the mirror in the driver's compartment or to the exterior of the vehicle.

Mirrors can be produced in a variety of shapes or forms as determined by the size and shape of the transparent foundation 102. In the present context, the most common shapes are rectangular, or rectangular with rounded corners, circles, and a variety of oval-like shapes. For convenience, but not by way of limitation, the examples consider generally rectangular mirrors as illustrated in FIG. 1B with a bottom edge 108, a top edge 109, a first side edge 110, and a second side edge 111.

Depth perception is a phenomenon associated in part with eyesight related to the controllable shape of lenses and the shape of the retina of the human eye as well as in part with binocular vision. The apparent change in the size of an object with distance is a function of the angle at which the light is transmitted by the object and of the assumption that the light is transmitted in a straight line.

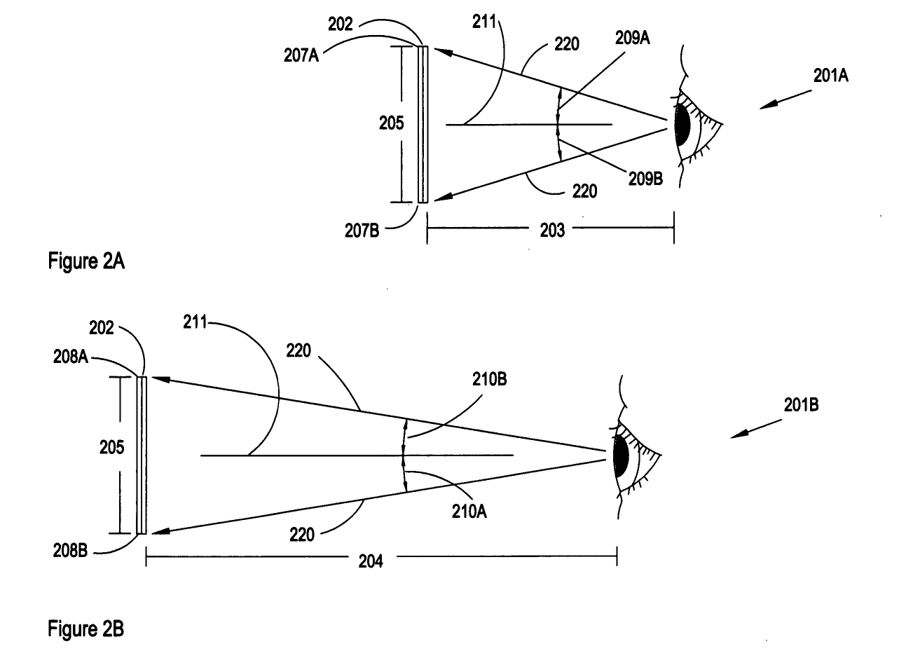

FIGS. 2A and 2B provide a simple, schematic illustration of the perception of relative size with distance. Two observers, 201A and 201B, observe the same object 202 at different distances, a short distance 203 for the first observer 201A and a long distance 204 for the second observer 201B. The actual size (height) of the object 205 is the same. Considering only the light from the top 207A and bottom 207B of the object 202 as seen by the first viewer 201A, the angle of incidence of the light 209A and 209B of the light 220 measured from the normal 211 (a line at right angles to the image) is relatively large compared with the corresponding angles 210A and 210B when the object 202 is observed by the second viewer 201B at a much greater distance 204, and the size 205 of the object appears to be smaller, with light from the top 208A and bottom 208B of the object. Perceived size of an object decreases with distance as a function of the decreased angle of incidence of the light.

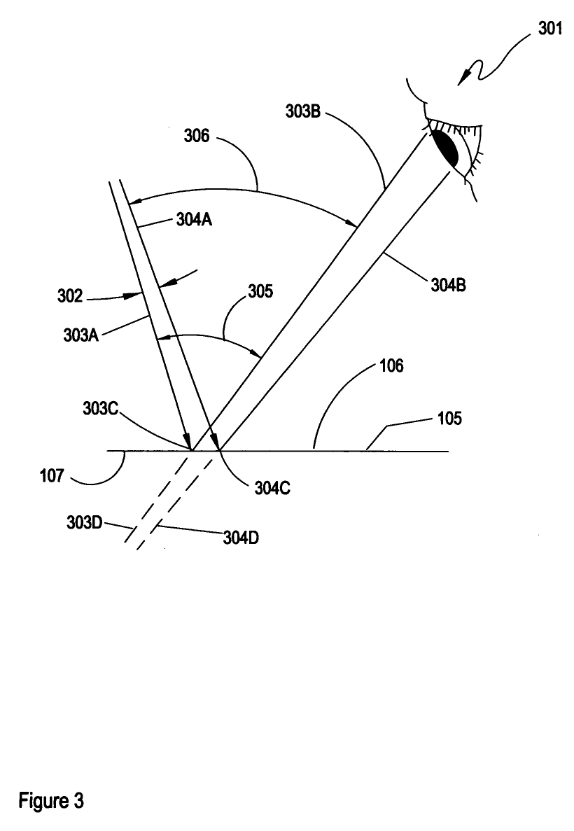

FIG. 3 illustrates the laws of specular reflection (or reflection from a flat or plane mirror), and in conjunction with FIGS. 1 and 2 provide the basis of how visually distinguishable indicators placed on the surface of a flat or plane mirror 101 can be used to estimate the distance separating a lead vehicle from a following vehicle. As in FIGS. 2A and 2B, for simplicity, light from the object 302 is indicated as coming from only two points 303A and 303B. Light, traveling in a straight line, contacts the surface 106 of the reflective material 105 separate points 303C and 304C, respectively. Each beam of light 303A and 303B is reflected at the same angle at which it contacts the surface 106 of the reflective material 105.

The image 310 formed by the mirror is not an actual image resulting from light being transmitted from an object, but a virtual image. The image 310 appears at the point where the reflected light 303B and 304B intersect “behind” the mirror. To the observer, the light appears to come by rectilinear propagation directly from the reflected image. See, for example, Martin and Hewell, 1975. Elements of Classic Physics. Pergamon Press. Elmsford, N.Y., chapter 6, pages 37-40.

### Example 1

Safe following distance is frequently expressed in terms of “car lengths” separating a lead vehicle from a following vehicle, with a common rule of thumb of “one car length for every 10 miles per hour of speed. Although vehicles vary in length, for purposes of estimating stopping distance the average length of a mid-sized American sedan assumed to be 18 feet (6.0 meters) which average also includes many light to medium pickup trucks, sports utility vehicles and medium sized vans. For convenience and to add a margin of safety, consider average length to be 20 feet, then corresponding following distances would be 60, 100, and 140 feet (approximately 20, 34, 46 meters) for 30 mph, 50 mph, and 70 mph, respectively.

The average width of most American passenger cars, light trucks, vans, and sports utility vehicles ranges from a fairly constant 5.5 to 6.0 feet (2 meters) for sedans to 6.0 to 6.5 feet (2.2 meters) for larger vans and pickup trucks. Height is far more variable ranging from less than 4 feet (for some “sports cars”) to over 6 feet for larger vans, pickup trucks, and large sports utility vehicles (1.3 to 2 meters). Because there is less variation in vehicle width and vehicle width does not require a road surface reference to estimate, vehicle width is the preferred image dimension to use to estimate distances separating a lead and following vehicle; however, the use of vehicle height is not excluded herein.

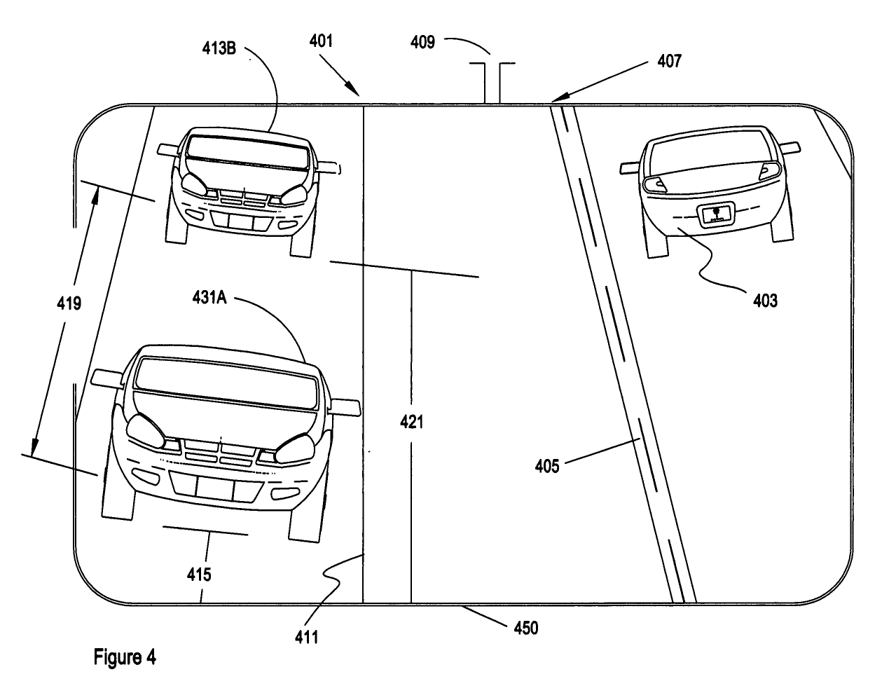

FIG. 4 illustrates the differences in the apparent height and width of images of vehicles as they may appear in the rear view mirror as a function of distance from the mirror.

In FIG. 4, the rear view mirror 401 of the lead vehicle is mounted by a bracket 409 in the driver's compartment near the top center of the windshield 407. To establish a familiar set of conditions, the illustration includes the image of a vehicle 403 moving in the direction opposite the lead vehicle. The roadway marking 405 separates the opposite lanes of traffic. Markings 411 separate lanes of traffic moving in the same direction as the lead vehicle.

The image of a vehicle 431A is shown at a distance 415 relatively close to the lead vehicle. The same following vehicle 413B is shown at a greater distance 421 from the lead vehicle. The increase in distance is described by arrow 419. The rear view mirror base reference point 450 for this illustration is the bottom line of the mirror. As explained by FIGS. 1, 2, and 3, the greater the distance an object is from the surface of a plane mirror, the smaller the reflected. In addition, distance from the mirror is also indicated by the image moving upward from the base of the mirror 450 with distance from the mirror.

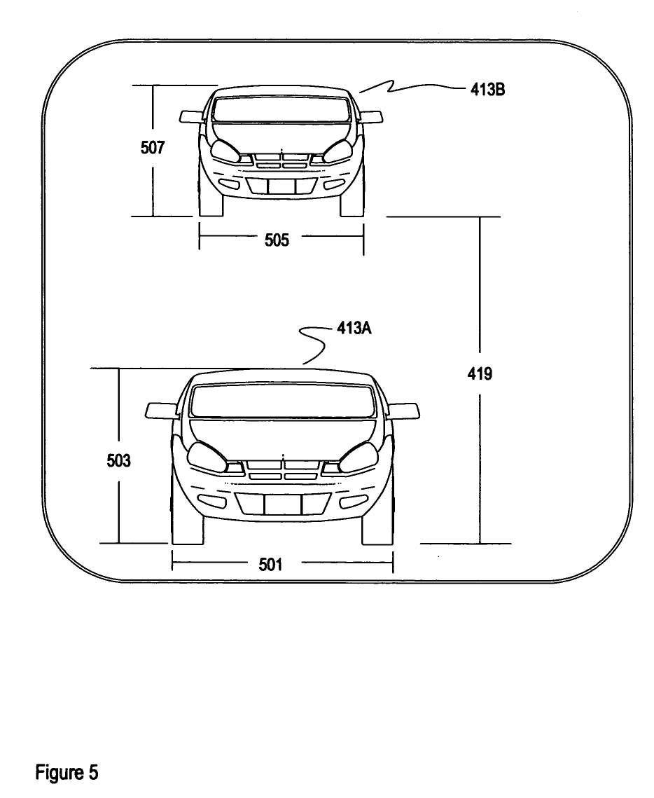

FIG. 5 illustrates the reduction in image size of by increasing the distance of a following vehicle from the lead vehicle. The width 501 and height 503 of the image of vehicle 413A are fixed by the distance separating the vehicles. As the distance 419 increases, both the height 507 and width 505 of the image 413B are reduced. In estimating distances separating vehicles based on size of the reflected images, height is less dependable than width. This in part is due to the greater actual variation in height among vehicles and also due to the fact that to compare height a road surface reference must be established.

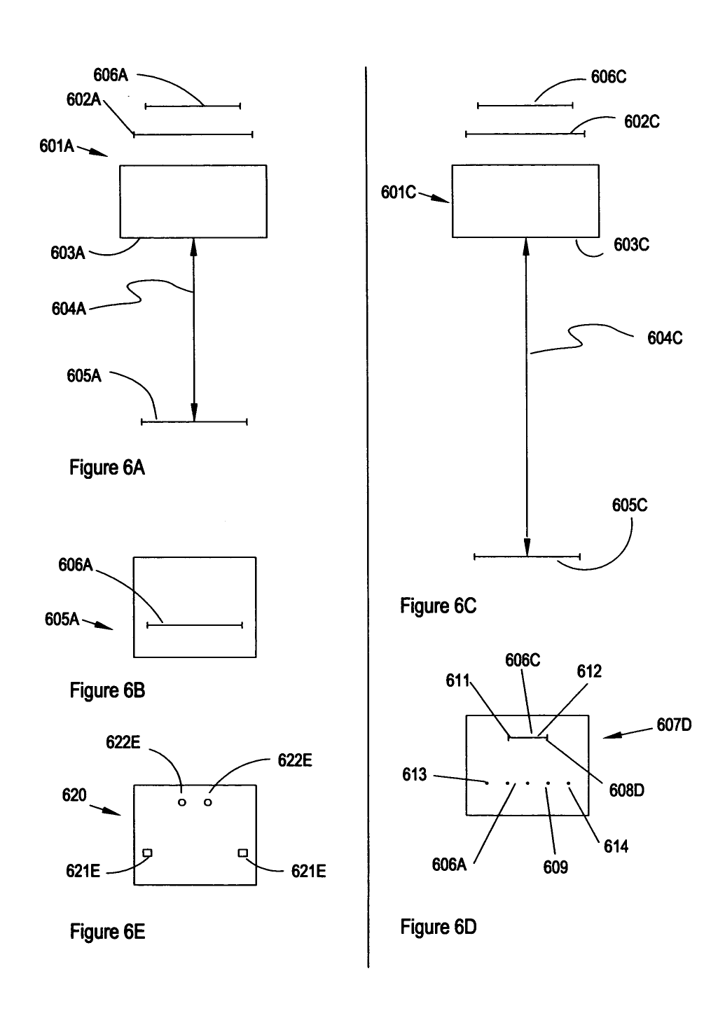

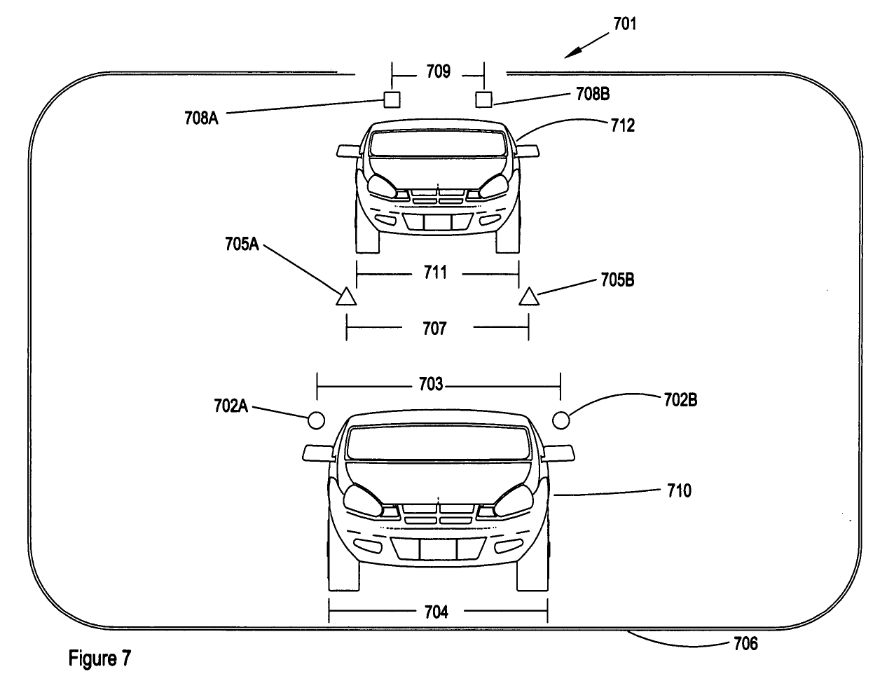

The practical function of the invention is initially illustrated in comparing two pairs of figures, FIGS. 6A and 6B with FIGS. 6C and 6D. FIG. 6E summarizes the comparisons.

In FIGS. 6A and 6C, the lead vehicle 601A and 601C, respectively, are parallel. The plane, rear view mirrors 602A and 602C are shown in association with the respective lead vehicles. For reference, the rear bumpers 603A and 603C are indicated, and distances 604A and 604C are given from the respective rear bumper (ie. distance from the mirror to the following vehicle minus distance from the mirror to the rear bumper). Distance 604C is greater than distance 604A. The width of the images 606A and 606C of the following vehicles 605A and 605C with respect to the corresponding rear view mirror are shown as lines 606A and 606C. The actual width of the following vehicles 605A and 605C are equal.

Although the actual width of both following vehicles, 605A and 605C, is the same, the image 606C is smaller than the image 606A. This is also illustrated in FIGS. 6B and 6D which diagrammatically illustrate the mirror images 607B and 607D. In FIG. 6B the width of the image of the following vehicle is indicated by the length of line 606A, and, in FIG. 6D the width of the image of the following vehicle is indicated by the length of the line 606C The width of the image 606C of following vehicle 605C is smaller (narrower) than the corresponding width of images 606A of the following vehicle 605A. The difference in the widths of the two images 606A compared to 606C is due to the greater distance of following vehicle 605C from the lead vehicle 601C compared with lead vehicle 601A.

Points 611 and 612 in FIG. 6D mark the limits or width of the image 606C, and for convenience of comparison, points 613 and 614 mark the limits of the image 606A, represented by broken line 609. In FIG. 6E, these limiting points are transferred to the face of a mirror 620 in which the limits of the width of the closed vehicle 606A are indicated by a pair of visually distinguishable (square) reference points 622E that are physically marked on the surface of the mirror. Similarly, the limits of the image of the width of the more distant vehicle 606C are marked by a second pair of visually distinguishable reference points (circles) 622E. The members of a pair of visually distinguishable reference points are identical in size, shape, and color and contrast with members of other pairs.

Adjusting for the distance from the mirror to the rear bumper of the vehicle, if the mirror of FIG. 6E is installed as a rear view mirror in a vehicle, any following vehicle, the image of which is as wide as the space between points 621E must be the distance 604A from the vehicle; any vehicle the image of which is as wide as the space between points 622E must be a distance approximately equal to distance 604C behind the vehicle; and any vehicle the width of the image of which is narrower than the space between points 621E and wider tan the space between points 622E must be further than distance 604A and not as far as distance 604C from the lead vehicle subject to the assumption that the vehicles on which the reference points were positioned and the width of the actual vehicle are comparable. Actual measurements indicated an assumed width the range of 5.75 to 6.25 feet (approximately 2 meters) is reasonable for most American passenger cars, pickup trucks, many vans, and sports utility vehicles.

In practice, the space between pairs of visually distinguishable reference points within which the image of a vehicle of average width falls for any specified distance is determined directly by use of s target of specified width (6.0 feet or 2 meters is an appropriate average) and positioning the target at designated distances from the mirror and directly measuring the width of the image of the target. For distances of 20, 40, 60, 80, and 100 feet (7, 14, 21, 28, and 35 meters), corresponding image widths are approximately 4.1250, 2.5000, 1.7500, 1.2500, and 1.1875 (100.4, 63.5, 44.45, 31.75, and 30.162 cm). These distances can readily be expressed as distances from the rear bumper of the vehicle, and hereafter references to distances between vehicles is from the rear bumper of the lead vehicle to the front bum[per of a following vehicle. The widths for the several distances are indicated by placing visually distinguishable reference points on the face of the rear view mirror. Each pare of points is equally spaced (one half of the image width) from the horizontal center of the mirror on a horizontal line across the mirror. Generally the most widely spaced points (representing images of the closest following vehicle) are placed on a common horizontal line in the lower half of the mirror with pairs of points representing greater distances on succeeding, higher horizontal lines. In an alternative configuration, two pairs of visually distinguishable reference points may be placed on the same horizontal line across the face of the mirror. The number of pairs is not critical; two or three pairs provides an adequate distance reference without masking a significant portion of the area of the mirror or becoming a distraction.

The plane mirror of a leading vehicle 701 illustrates a first pair of visually distinguishable reference points 702A and 702B, each circular in shape in which the space between the two reference points equals the width of the image of an average vehicle, approximately 6 feet (2 meters) when the vehicle is 20 feet (7 meters) behind the lead vehicle. A second pair of visually distinguishable points 705A and 705B, each triangular in shape is positioned on the surface of the mirror 701 above the first pair of points 702A and 702B and like these points are aligned on a line parallel to the bottom of the mirror 706. The space 707 between the two triangular visually distinguishable reference points 705A and 705B equals the width of an average vehicle 40 feet (14 meters) behind the lead vehicle. The space 709 separating a third pair of visually distinguishable reference points, rectangles, 708A and 708B also aligned on a line parallel to the bottom of the mirror 706 equals the width of the image of a vehicle of average width 60 feet (21 meters) behind the lead vehicle.

The image of the width 707 of the first vehicle 710 is greater than the space separating the first pair of visually distinguishable reference points (circles) 702A and 702B. Based on this observation, the vehicle 710 must be closer than 20 feet (7 meters) to the lead vehicle. The image 711 of the width of the second, more distant following vehicle 712 is approximately equal to the space separating the triangular visually distinguishablet, reference points 705A and 705B. The more distant, second following vehicle 712 is approximately 20 feet (7 meters) behind the first following vehicle 710. Reference to the third pair of visually distinguishable reference points (rectangles) 708A and 708B shows the second vehicle is closer to the lead vehicle than the distance equated with the space separating the points 708A and 708B.

The space between each of the three pairs of visually distinguishable marker points as marked on the surface of a plane mirror are determined by direct measurement of a target; the image width 703 at 20 (7 meters) for an average vehicle is 4.125 inches (100.4 cm), at 40 feet (14 meters), 2.50 inches (63.5 cm), and at 60 feet (21 meters), 1.75 inches (44.5 cm).

### Example 2

In practice, even if the following vehicle is not directly aligned with the center of the mirror, the distance references still provide a reliable estimate of following distance. Moreover, as an average driver realizes, the relative position of an image in the mirror can be altered with a minor change in head position.

The visually distinguishable reference points can be affixed to the surface of the rear view mirror by any of a variety of methods. Regardless of the method, members of a pair should be aligned on a line horizontal to the bottom of the mirror. Points, regardless of shape should be from approximately 0.125 to 0.25 inch (3-6 mm) in width, and spaced equal distance from the horizontal center of the mirror. Points can be formed in the surface of the mirror and appropriately colored, or applied to the mirror. A convenient is points appropriately spaced on an adhesive, transparent type that can simply be applied to the surface of a mirror.

### Example 3

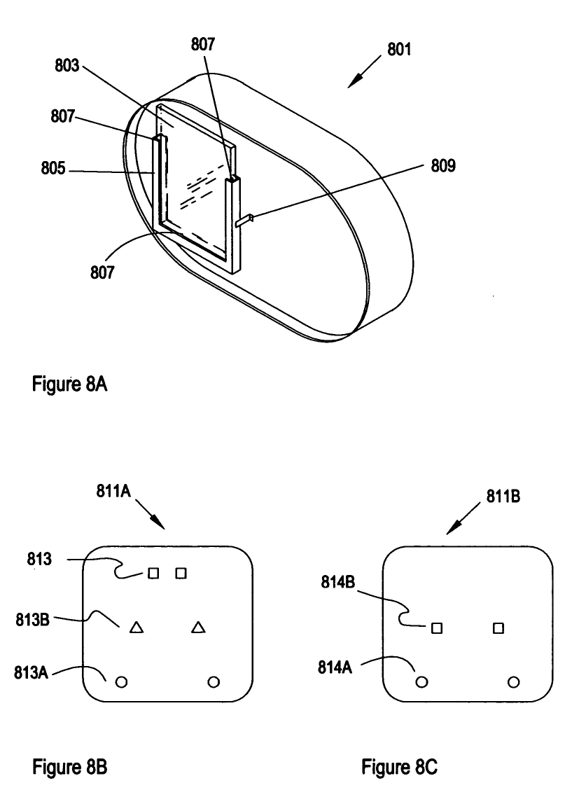

In a method related to the transparent tape is illustrated in FIGS. 8A, 8B, and 8C. The mirror is fitted with a light frame in which transparent plastic inserts with appropriate markings can be inserted. The frame positions the insert appropriately over the face of the mirror. This allows changing to accommodate different distances when the vehicle tows a trailer. It is commonly, but not exclusively appropriate for outside, rearview mirrors.

The outside rearview mirror 801 of FIG. 8A has a reflective surface 803. A frame 805 with a groove 807 extending down both sides and across the bottom is attached to the mirror unit by brackets 809.

FIGS. 8B and 8C illustrate plastic inserts 811A and 811B of dimensions to allow either one of them to be positioned in and securely held by the groove 807. Pairs of reference points 813A, B, and C are positioned to indicate following distance from the rear bumper of the vehicle. In FIG. 8C, reference points 814A and 814B are spaced to compensate for distances from the rear of a towed trailer.

### Example 4

The positioning of visually distinguishable reference points as described is applicable for plane, rearview mirrors located in the interior of a vehicle, or for rearview mirrors located exterior of the driver's side.

In order to improve their field of vision, commonly rearview mirrors mounted on the exterior of a vehicle opposite the driver's side are slightly convex, rather than plane or flat in surface geometry. This curvature reduces the “blind spot,” and also reduces the size of reflected images at any given distance. The degree of reduction is a direct function of the degree of curvature. Although image size could be expressed in theory, appropriate image widths can be determined experimentally as described for plane mirrors, and visually distinguishable reference points appropriately positioned of the face of the convex mirror. Based on average image sizes from convex mirrors on a variety of passenger cars, pickup trucks, vans, and SUV's, appropriate spaces between pairs of visually distinguishable reference points for the image of a vehicle of average width are as follows: 3.0625 inches (8.78 cm) for 20 feet; 1.50 (3.81 cm) for 40 feet; 1.000 inches (2.54 cm) for 60 feet; 0.875 inches (1.22 cm) for 80 feet; and 0.1875 inches (0.48 cm) for 100 feet. To avoid confusion, the same size, color, and shape of the pairs of visually distinguishable reference points should be used for all mirrors.

Preferred embodiments of the invention have been described using specific words, terms, devices, and conditions. The words, terms, conditions, and devices are used for illustrative purposes only, not as limitations to the scope of the invention. It is to be understood that changes and variations may be made by those of ordinary skill in the art without departing from the spirit or scope of the invention. In addition, it should be understood that aspects of the various embodiments may be interchanged in whole or in part to yield new combinations that are anticipated by the invention. Therefore, the spirit and scope of the appended claims should not be limited solely to the descriptions and examples herein.

What is claimed is:

1. A device that allows the operator of a vehicle to estimate the distance separating the driver's vehicle from a following vehicle comprising:
A at least one mirror, said at least one flat mirror comprising a first, reflective face, a back surface, a two-dimensional, geometric shape, said shape being described by a bottom edge, a top edge, and opposite, side edges;
B a frame structure to support and protect said at least one mirror and to provide a means by which said at least one mirror can be attached to a vehicle with said first, reflective face facing reward as viewed by the operator of the vehicle; and
C at least one pair of visually distinguishable reference points positioned on said reflective face of said at least one mirror and spaced so as the distance of a following vehicle can be estimated by the width of its image in comparison with said at least one pair of visually distinguishable reference points.

2. The device of claim 1 wherein said at least one mirror is a plane mirror.

3. The device of claim 1 wherein said at least one mirror is convex in surface geometry.

4. The device of claim 1 wherein said at least one mirror is generally rectangular in shape.

5. The device in claim 1 wherein said at least one mirror is generally oval in shape.

6. The invention of claim 1 wherein two flat one flat mirror is positioned on the exterior of a vehicle on the driver's side, a second flat mirror is positioned within the driver's compartment and in convenient view of the driver, and a third, convex mirror is positioned on the exterior of the vehicle on the side opposite the driver's side.

7. The invention of claim 1 wherein more than one pair of visually distinguishable reference points are positioned on the surface of said at least one mirror.

8. A clear, adhesive type of material capable of being applied to rearview mirrors of a vehicle, wherein visually distinguishable reference points are marked on said clear adhesive type of material.

9. A device to adapt a rear view mirror to allow the operator of a vehicle to estimate the distance separating a vehicle from following vehicles comprising:
A a frame element capable of being attached to the rearview mirror of a vehicle, wherein said frame element is adapted to receive and to position an insert element over the face of said rearview mirror;
B a transparent insert element adapted to being held by said frame element, said insert element having visually distinguishable reference points to allow the operator to estimate the distance to a following vehicle based on the relative size of the reflected image of said following vehicle.

10. The device of claim 9 wherein said visually discernable reference points are positioned directly on the insert element.

11. The device of claim 9 wherein said visually discernable reference points are placed on a transparent material that is applied to said transparent element.
